(19) United States
(12) Patent Application Publication
(10) Pub. No.: US 2003/0148845 A1
(43) Pub. Date: Aug. 7, 2003

(54) Self-contained continuously-variable transmission with mechanical integral torque converter having automatic drive control

(76) Inventor: Teodoro Rodrigo Borbolla Gonzalez, Jalisco (MX)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/168,056

(22) PCT Filed: Dec. 15, 2000
(86) PCT No.: PCT/MX00/00055

(51) Int. Cl. F16H 15/48

(52) U.S. Cl. 475/185

(57) ABSTRACT

An automatic transmission that has a planetary system which receives the power by the porter and transmits it initially in a direct way with low pitch rate by the sun gear, and afterwards in a regulated manner, to keep the optimum engine power, through a planetary system installed inside a growing diameter cylinder impeller, coupled to the ring gear. Such system consist of several adjacent rollers that have a pitch and splines system for making a proper contact with the cone, which receive the traction form the conic impeller, and transmit it to the central gear with a variable speed, depending to the demanded torque , measured by a sensing spring mechanism installed at the sun gear, that can be manually adjusted to maintain an overdrive or economy output torque. The sun gear is coupled to a shaft (which operates initially as a transmission shaft), with a helical slat which sets the receptor system to an axial position, corresponding to the demanded power, to make contact certain diameter of the cone, and though, synchronized the shift of sequence , by subtracting the unequal speed between the shaft coupled to the central gear, and the sun gear.

### BACKGROUND

The invention offers a new, simpler assembly of an Infinitely Variable Transmission (IVT), of which there are several designs. Some designs base their operation on the change of speed of some component (normally the sun gear) of a planetary gearing system, to provide variable speed on the output shaft that is integrated directly or indirectly to another one of it's components (normally the annular gear), as is the case of U.S. Pat. No. 5,564,998. This change is regulated by a variator mechanism which employs sliding rollers in one or many pairs of thoroidal discs such as disclosed in U.S. Pat. No. 5,395,292 or through the use of belts that operate in poles with varying diameters as described in U.S. Pat. No. 4,553,450. Another design uses a torque converter in which hydraulic fluid is used between the turbine and the pump to vary it's traction as illustrated in U.S. Pat. No. 4,644,821. There also exists the continually variable transmission like the one disclosed in the U.S. Pat. No. 4,229,985 patent that uses a system of conic rollers with an intermediate ring to modulate speed by varying its angle.

All of the described inventions suffer from great losses of power that in a higher or lower degree, affect the efficiency of the engine. In addition, many have a higher degree of complexity in it's manufacture, making the mechanisms more expensive in their operation and maintenance.

### Advantages on the State of the Art

1. To control the vehicle's motion through the variations of the transmission and not by the engine's revolutions per minute, so that the engine operates at a constant optimum design speed, under every condition.

2. Improve fuel economy by 30% or above, increase time between service intervals, and improved serviceability.

3. Provide immediate throttle response under any condition.

4. To have additional back up power for adverse conditions, such as excess load, steep hills or sudden acceleration.

5. Provide a self-controlled infinitely variable transmission, which operates without the use of external control such as a computer.

6. Provide a completely automatic drive mechanism with additional power available when required, reducing the shifting of drive mechanisms by the operator.

7. Provide a regulating auto-controlled Constant Speed Drive (CSD), using the transmission inversely; by providing the traction through the output shaft.

### BRIEF DESCRIPTION OF THE FIGURES

The invention is best understood utilizing the following figures, where

FIG. 1. Is a full illustration of the transmission; allowing view of the primary sequence on the top part of the conic body, and the variable sequence on the lower part.

FIG. 1A. Is a cross section view of the transmission (illustrating the fix-type rollers) operating in the primary sequence.

FIG. 1B. Is a cross section view of the rear part of the transmission operating in the primary sequence and normal drive; it also demonstrates the shift mechanism for Cruise and Neutral.

FIG. 1C. Is a plan view of the unidirectional clutch - bearings (17 and 18) in locked position.

FIG. 2A. Is a sectional view of the transmission (showing the fix-type rollers) operating the variable sequence.

FIG. 2B. Is a sectional view of the rear part of the transmission operating in cruise drive, it incorporates the shift mechanism from Normal to Cruise, Neutral and Reverse.

FIG. 2C. Is a sectional view of the rear part of the transmission operating in cruise drive, as indicated in cut line 2C-2C of the FIG. 2B in which the rear gear train is visible.

FIG. 3. Is a detailed perspective view of the locking system of the sun gear and the mechanical torque sensor for the variable transmission.

FIG. 4A. Is a schematic view of the moving parts of the Primary Transmission.

FIG. 4B. Is a schematic view of the moving parts of the Variable Transmission with fix-type rollers.

FIG. 4C. Is a schematic view of the Variable Transmission with pitching rollers.

FIGS. 5A and 5B Show a simplified view of the contact angle of the impeller with the fix-type or pitching rollers shown in FIGS. 4B. and 4C.

FIG. 5C Shows an isolated view of the grooves and the pitching system of the rollers, shown in FIGS. 4C and 5B.

FIG. 6A and 6B are simplified figures of the back side view of three displacement positions of the Variable Transmission System shown in FIGS. 4B. and 4C.

### SUMMARY OF THE INVENTION

The invention is a Self Contained Infinitely Variable Transmission with an Integral Mechanical Torque Converter and an Automatic Drive Control, which consists of three systems that interact harmoniously sharing components and are defined as follows:

A) Primary Sequence system and a two position traction synchronizer based on a planetary gear system (3, 4 and 5) which consists of a primary gear (1) with an annular gear mounted on a planet carrier (2), an annular gear (3) and an unidirectional clutch (17) mounted on a cylindrical impeller of increasing diameter (10) a set of 2 or more planets (4) a sliding sun gear (5) a primary traction and control shaft (7) and a double coupling shaft (19).

B) A sliding control system of the traction receptor gear system, and overdrive/economy control that consists of centrifugal counterweighs (8) a sliding sun gear (5) a primary traction and control shaft (7), a central splined bar (21), a positioning spider (12), a friction disk (22) and a lock plate (6), a torque sensor consisting of a spring that can be spiral (9) and a shifting mechanism of the torque sensor (20).

C) Mechanical torque converter system, of constant speed consisting of a primary traction and control shaft with an hellicoidal slot (7), a central splined bar (21), an annular gear (3), a cylindrical impeller of increasing diameter (10), a system with several rollers with shafts and a rear gear (13), a central gear (15) a second planetary gearing system (14) fixed to a spider (12), an unidirectional clutch (18) mounted on the outer shaft (16), and a double coupling shaft (19).

The primary sequence system consists of a primary gear that reduces the engine R.P.M. and transmits it to the planet carrier (2) as demanded by the accelerator. This system, during the initial acceleration from idle to the optimum engine design speed, keeps the annular gear (3) fixed by means of the unidirectional clutch (17); both mounted on the conic impeller (10). The sun gear (5) then moves backwards unlatching from the lock plate (6), and transmits the torque to the primary traction and control shaft (7), which in turn transfers the torque to the double coupling shaft (19).

Once the optimum engine design speed has been achieved, the centrifuge counter weights (8) move the sun gear (5) forward, unlatching the primary traction and control shaft(7) from the transmission, and locking it in fixed position to control the variable sequence.

During the primary sequence, the two-position traction synchronizer by means of the second unidirectional clutch (18), restricts the outer shaft (16) from spinning during the initial transmission operation, in order to allow the free rotation of the primary traction and control shaft (7). Once the variable transmission starts operating, the outer shaft (16) will reach the same speed as the double coupling shaft. The second unidirectional clutch will then engage both shafts (16 and 19) so that the outer shaft will now transmit the traction, and the sequence change is synchronized.

The deployment control system of the traction receptor gear system, works as follows: Once the sun gear is placed in it's locked position up front, it perceives the torque's reaction delivered to the transmission, it will surpass the sensor spring (9) supported by the friction plate (22), and will cause the primary traction and control shaft (7) to spin a certain amount of rotations depending on the torque that surpasses the friction, and through the hellicoidal groove and the splines of the central bar, will deploy the positioning spider (12) lengthwise. In this manner the roller train system moves axially through the primary traction and control shaft (7), up to the required position to maintain the said RPM's of the conic impeller (initially all the way forward, because it requires more torque).

The overdrive and economy control system, by means of a mechanism, increases or reduces manually the spring sensor's tension (9), calibrating from inside the vehicle the operation speed of the engine (normally+/−500 RPM), depending on the drive selection. This mechanism will be able to freely rotate in opposite direction within the normal economy range, to dampen the inverse torque during deceleration.

In the mechanical torque converter system, the modulation of the variable pitch rate operates as follows: Once the sun gear (5) has been stopped, the primary transmission and control shaft (7) is engaged to the positioning spider (12), which will deploy to a distance corresponding to the received torque. Meanwhile, the annular gear (3) is now moved by the planet gears (4), releasing the conic impeller (10) from the unidirectional clutch (17), transmitting the traction to the non-skid rollers system (11)(in the above described controlled position) engaged by it's back gear (13) to a second planetary system (14) joined to the positioning spider (12) by the pivoting arms (32), transmitting the traction through the central gear (15) that is joined to the outer shaft (16) so the double coupling shaft (19) now rotated by the outer shaft (16), operates with a variable output speed rate, according to the contact diameter with the conic impeller (10). This position is automatically controlled when the receptor system (11, 13, 14, 15 and 16) is moved lengthwise by the spider (12) through the helical groove of the control shaft (7) along with the central bar's splines(21).

The mechanical torque converter system can be adapted to work in two ways:

a) Non-skid fix-type rollers (11): Consisting of rubber or compound material rollers, with an axel that is coupled to the back gear. Rollers can be made of metal, using traction fluid for adequate adhesion.

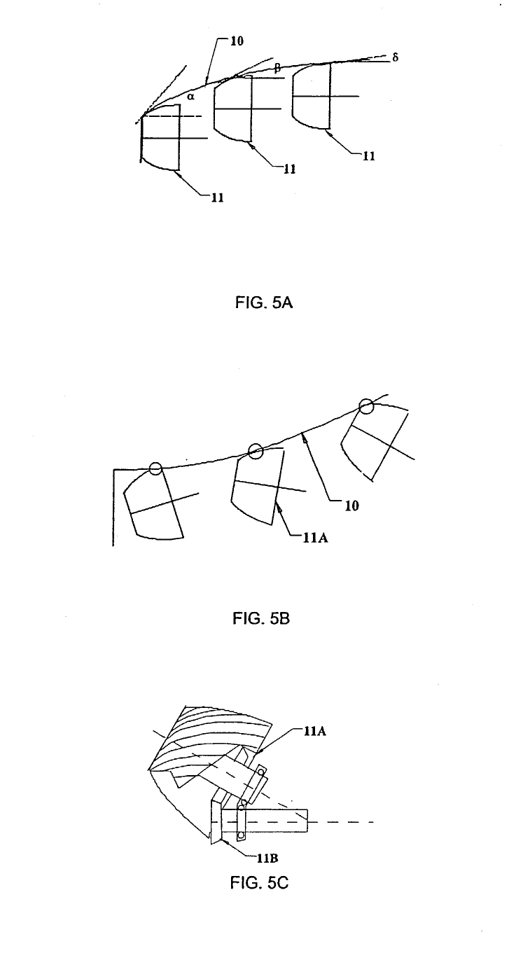

b) Grooved pitching rollers (11A): Consisting of parabolic shaped rollers with helical grooves and it's axel with internal gears linked to the rear gear shaft (FIG. 5C).

In the pitching rollers system (11A), their axel incorporates a gear that rotates around the guide gear (11B) linked to the back gear (13) in a 180° range as the traction receptor system moves axially, causing the contact area of the rollers with the impeller to be deployed, initially it will be with the tip of the rollers and when making the complete span (180°) with the heel (or in the inverse way), so we get a limited contact point between them, and a different rate of pitch. The rollers have helical grooves (11A) corresponding to the contact angle with which they engage with the impeller (10), and whose grooves are straight and lengthwise along to their inner surface.

The mechanism has the following characteristics:

1. The engine power is completely transmitted, except for losses due to friction, since a mechanical device of variable pitch is used for torque modulation.

2. It greatly improves the vehicle's driveability, since it has a auto-controlled pitch rate by the engine torque; it has a synchronized shift sequence system, making it easy to operate, optimizing the engine operation, extending it's working life and maintenance laps, increasing fuel economy.

3. It can be used in automotive equipment as a transmission or as an auxiliary back up output speed control in any other type of machine or equipment.

4. The engine works at a constant speed, so accessories such as a generator or electric alternator with fixed frequency for alternating current, or hydraulic pumps with constant flow can be attached.

5. It is axially assembled and it has relatively few moving parts; making it easier to build, and has fewer failure modes.

6. It has a wide range of mechanical advantage, that is why it only requires an inversing gear for reverse operation, but a gear train with several speeds or just with a single one for cruise speed, can be incorporated depending on the apparatus's requirements.

7. Other accessories such as a torque indicator may be easily added, as well as control systems such as a centrifuge governor, hydraulic, or electric controllers, for the deployment of the variable transmission.

8. If it is used in an inverted way, providing traction to the output shaft, it can work as a Constant Speed Drive at the input shaft.

### DETAILED DESCRIPTION OF THE INVENTION

The invention is an Infinitely Variable Transmission using a cylindrical impeller with an increasing diameter (10) that may be conic or parabolic and is powered by an engine transmitting a variable torque, while maintaining the same angular input speed.

Within the impeller (10), the torque is transmitted through a roller traction system (11). The rollers are rotated at a variable speed depending on the diameter where they make contact, and are deployed along the inside of the impeller automatically, depending on the power supplied by the engine, and transmitting it to the output shaft (19), at an exact pitch rate, providing the necessary torque to maintain or increase the vehicle's speed instantaneously.

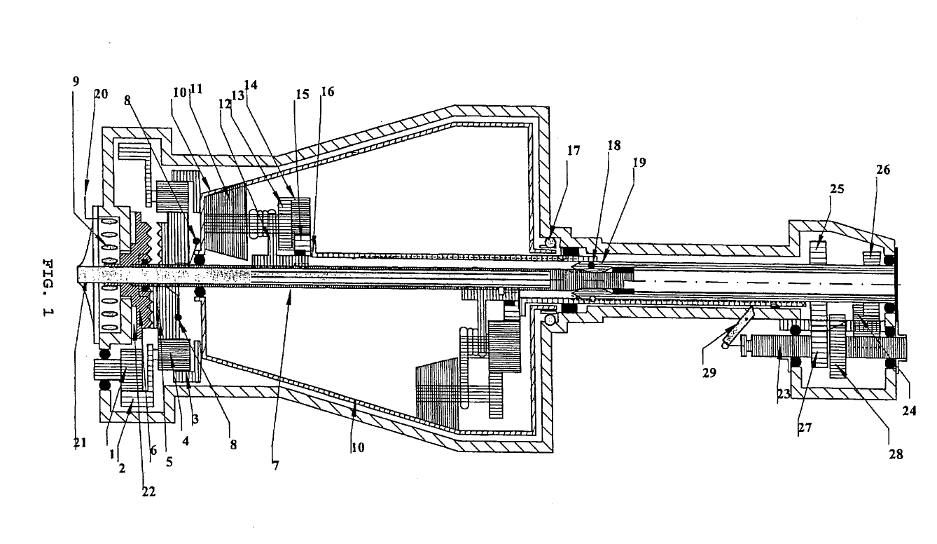

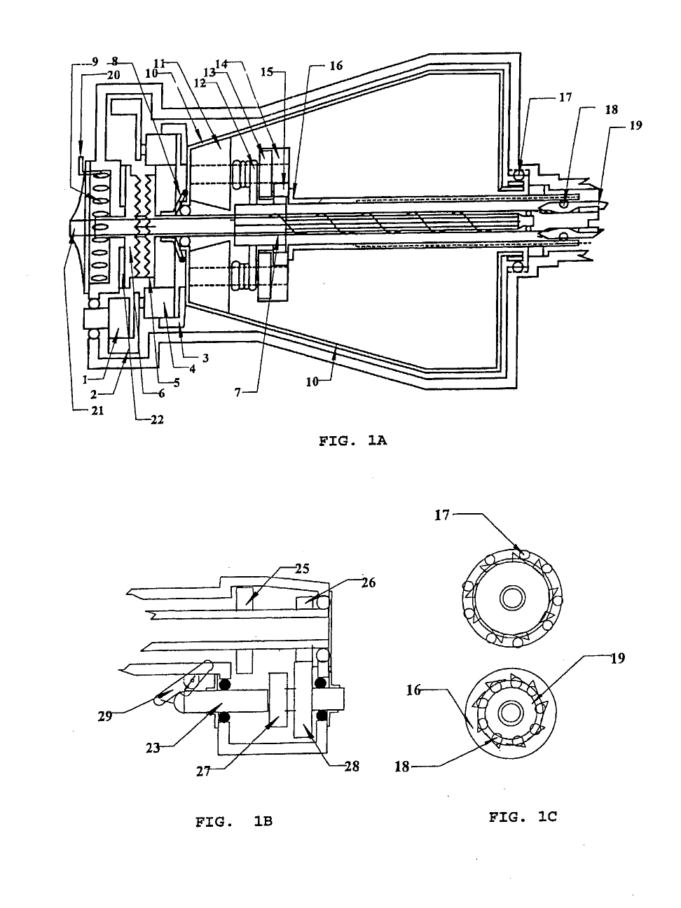

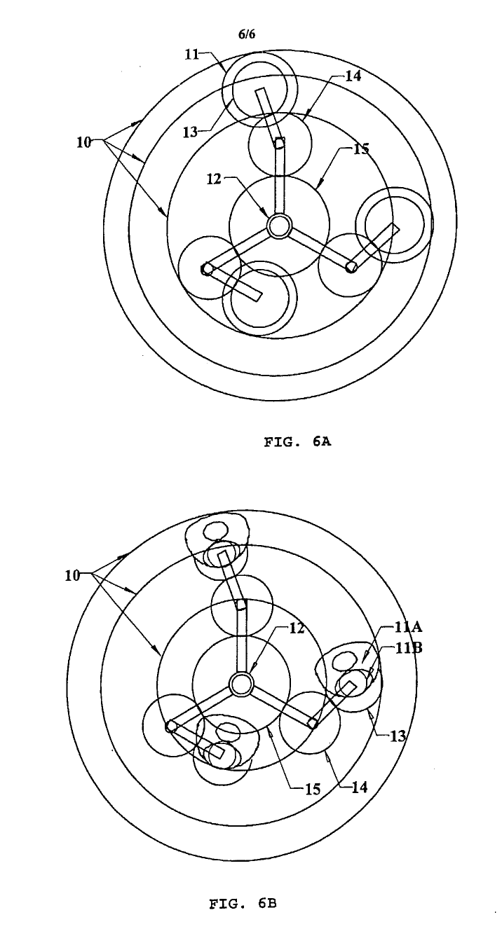

The IVT is made up of two epicyclical gears and rollers systems (FIG. 1A parts 3, 4 and 5 and FIG. 6A and 6B parts 10 to 15), with concentric shafts (7 and 16), that interact to provide a regulated output transmission. As a result, the operation speed of the engine remains constant and provides the traction with a speed and torque corresponding to the power demanded (FIG. 2A) for the vehicle instant speed.

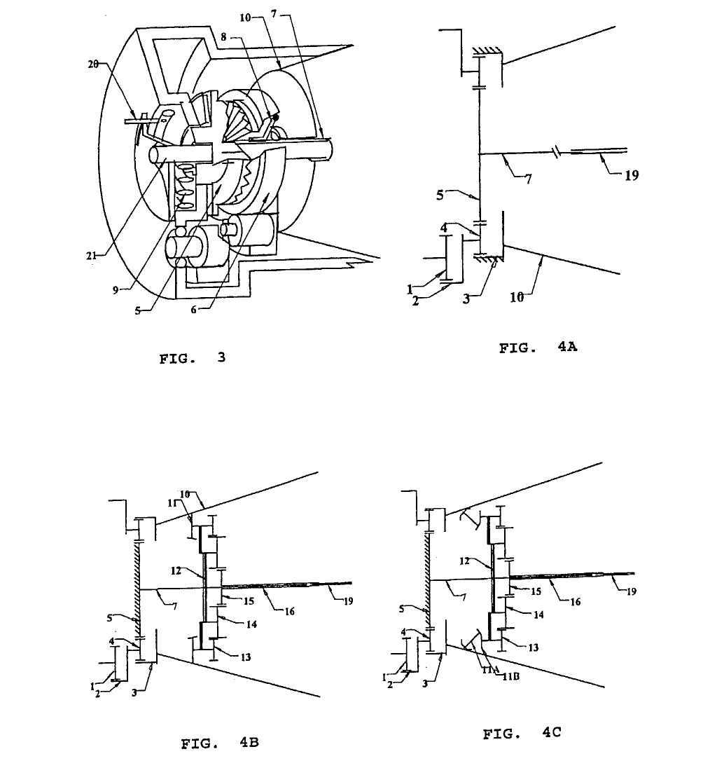

The invention consists of an initial take-off transmission that operates with a low pitch rate by the sun gear (5) through the primary traction and control shaft (7) while the engine achieves optimum operation speed; and the other through the rear epicyclical gear system (FIG. 4B or 4C), linked to the annular gear (2) of the front epicyclical gear system. The planetary system receives the traction in a variable way since the inner race is a cylinder of increasing diameter (10) that may have grooves through it's interior surface so the rollers (11) can adequately adhere. Inside the cylinder a roller system (typically 3 planets with 3 link gears (11), (13) and (14) that may be fix-type (FIG. 6A,11) or with a pitching mechanism (FIG. 6B-11A), deploys lengthwise and transmits torque to the vehicle traction through an outer (See figs.4B, 4C).

The fix-type rollers (11), may have a curved shape so that when they are at the forward position the tangent line to the point where they make contact with the cone, they will have a relative angle with the impellers conicity (FIG. 5A α,β. and γ) that compensates the tendency of a wheel to turn when spinning on an inclined surface, and which is reduced as the track or inside surface of the cone (10), increases it's radius. The sectional diagram (FIG. 1 and 2), shows the fix-type roller option for clarity.

The fix-type rollers (11) can be substituted by pitching rollers (11A), which rotate translaterally around the gear shaft (11B), with a tendency to climb to increase the contact with the impeller (19). If this option is used, an additional gear must be included to the front planetary system to avoid the reverse gear; such that both the primary and the variable systems will rotate in the same direction.

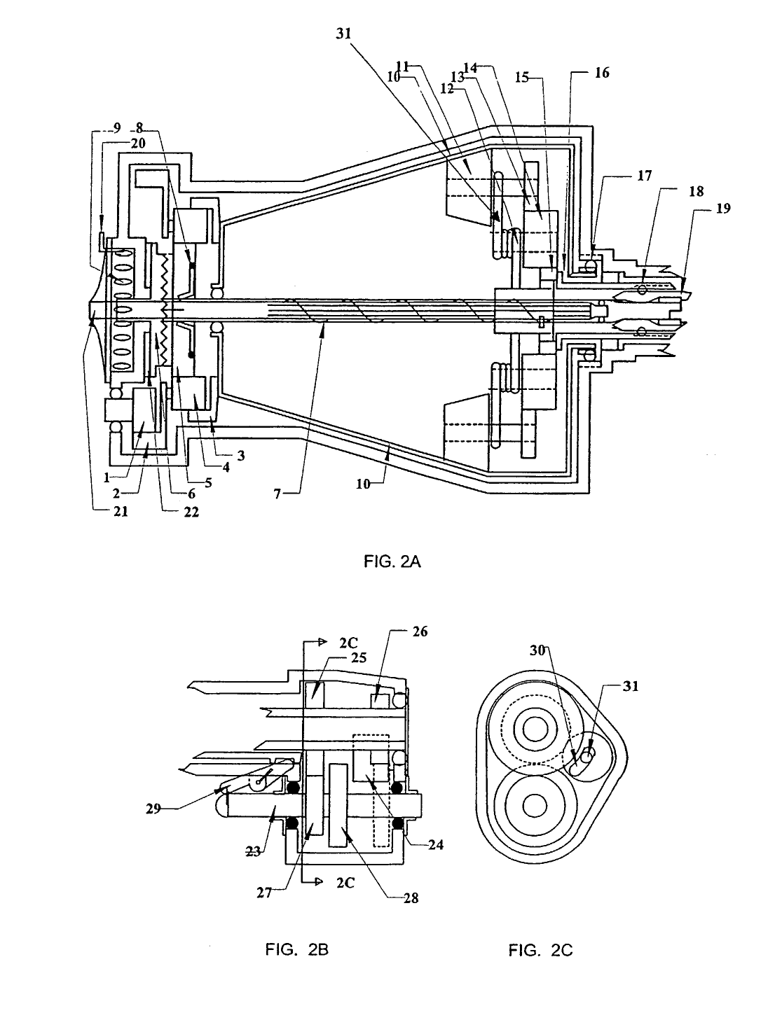

The traction control utilizes a torque sensor (9) linked to the positioning spider's deployment system (5, 6 and 7). The system also includes an overdrive device (20) which, depending on the selection made, will increase the engine operation RPM, to increase the output torque when an excessive load or when a sudden acceleration is required. It can also reduce the RPM in an inverse way (FIG. 3).

### Operation

Turning to the operation of the invention initially, the torque is supplied to the primary gear (1), and to the planet carrier (2) where through the planet gears (4), the sun gear (5) and the second annular gear (3) is transmitted indiscriminately; since the sun gear (5) has a higher mechanical advantage because it's pitch rate is less than the variable system's (11 thru 16), (even when it is at its minimum pitch ratio), this gear (5) will then begin to rotate. Consequently, the second annular gear (3) will tend to react in an opposite direction, but the unidirectional clutch (17) prevents it (FIG. 1C).

Since the sun gear is spring loaded, it will remain in its rearward position. Then the primary traction and control shaft (7) firmly linked to the sun gear (5), will engage with the inner grooves of the double coupling shaft (19) thus operating the primary traction.

The speed can be maintained within the take-off range, or if demanded, will be increased until it achieves the optimum engine operating speed. At that moment, the centrifuge counterweighs (8) linked to the sun gear (5), will extend causing it to move forward, stopping and locking the sun gear with the lock plate (6) being now linked to the torque sensor mechanism (9), and disengaging the primary traction and control shaft (7) from the double coupling shaft (19).

Keeping the sun gear locked in the forward position, the controlled sequence begins operating. The transmission will now operate through the second annular gear (3) coupled to the impeller (10) that will rotate in the same direction as the primary transmission and will be freed from the unidirectional clutch (17); transmitting the traction to the second planetary system inside of the impeller (11, 12, 13 and 14), which will deploy axially and is linked by the central gear (15) to the outer shaft (16).

The outer shaft (16) has the second unidirectional clutch integrated (18), since all along the shaft there are grooves shaped in such way that will limit the rotation of the balls (FIG. 1C), operating as the outer race characteristic of this kind of clutch, which during the operation of the primary transmission will not allow it to interfere with the primary traction and control shaft (7), but when it has higher relative speed than this shaft, will hook the balls transmitting now the traction to the double coupling shaft (19) and thus synchronizing the change of sequence.

Once the impeller (10) is turning, it will engage the outer shaft (16) with the rest of the transmission as described above, hooking up the deploying spider with the helical groove (typically with 5 turns) of the primary traction and control shaft, which function is now the control of the transmission. The reaction torque of the sun gear will allow the shaft to turn backwards proportionately to this torque, and in combination with the splines of the central bar (21) that may have a helical path to compensate for the backwards component resulting from the contact force of the rollers (11) with the cone (10); it will deploy the roller system (11-16) initially backwards, but when raising the impellers traction, it will increase the torque and they will be brought back to their natural position (corresponding to the optimum RPM designed for the engine and that is, going forward).

When the demand for power is increased, the sun gear rotates overcoming the sensor spring tension and the friction of the friction disk (22), making the primary traction and control shaft spin proportionally to the torque. The roller system (11-16) will move forward to contact a smaller diameter of the impeller until the vehicle raises its speed and consequently the torque will decrease, and the roller system will move backward to contact a bigger diameter of the impeller so that without increasing the impeller's speed, the speed of the rollers (11), the linking gears (14), the central gear (15), the outer shaft (16), the double coupling shaft (19), and consequently the transmission speed will increase, while the engine maintains a constant speed (FIG. 6A and 6B).

The same thing happens with the pitching roller option (11A), in this case, the rollers will spin transitorily (as far as they contact with the impeller), on the guiding gear (11B) linked to the rear gear (13) and to the rest of the system, which has been already explained. So that, according to the pitch angle, they make contact with the tip or heel of each roller, as so to isolate the contact point and avoid skidding (FIG., 5B).

Should it be required to over speed the engine operation during the controlled sequence at any given moment; the external tip of the sensor spring must be rotated (9) through the overdrive lever (20), as so to increase the spring's tension (9), so that the mechanism requires more power to defeat the control system (FIG. 3) forcing the sliding system (11-16) to stay up front more than it normally would, operating with less speed and more torque, and the opposite of this if it is desired to operate softly (normally at high vehicle speeds), the inverse operation will be carried out.

In the same way, if the cruise selection is armed, when the transmission reaches certain number of output revolutions per minute -proportionately to the deployment of the output shaft (16), the friction plate (29) will be activated, moving forward the counter shaft gear assembly (23), to obtain a greater pitch rate. Since the output torque will be increased abruptly, the sensor will immediately move forward the group of rollers (11-16) to a position in which the engine is stable again in it's best operating condition, and will continue operating with the controlled traction system; when reducing the vehicle's speed under said R.P.M., it will go back to it's original gear relation with the same inverse process.

If the speed is reduced in a way that an excessive torque be required (corresponding to the primary sequence), the roller system (11 through 16) will initially deploy forward completely, but since the torque is bigger than the one corresponding to this position, the sun gear will be unlatched, liberating itself from the halting position, to then transmit the traction in a primary sequence.

When receiving a negative torque (as in a decrease in vehicle speed), the sun gear (5) will deploy to it's rear position, spinning the three elements of the planetary system (3, 4 and 5), then the traction will be void until the primary traction and control shaft's speed (7) be higher than the outer shaft's (19); at this moment, the impeller (10) will be locked once more, through the unidirectional clutch (17), operating now the primary sequence again.

If during that event, acceleration is demanded again, the primary traction and control shaft (7) will increase the speed and the counterweights will deploy, in a way that the sun gear (5) will move to the front position, and the variable sequence will continue to operate.

The IVT utilizes an automatic mechanism for cruise or high speed, that when engaged, and the roller system (11 thru 16) achieves a certain deployment, an acting lever engages a multiplier gear (27) with a bigger gear at the output shaft (25). When decelerating, the roller system (11 through 16) will go back, and should these return forward to this said position, it will disengage the multiplier gear, now linking gears 26 and 28 again (FIG. 1B).

For the reverse operation, it should be selected manually while the engine runs in idle, by completely moving rearwards the counter shaft (23) deploying the reverse shaft (31) through the positioning slot (30) and engaging the reverse gear (24).

The lubricating system of the variable transmission will be routed through a vein inside the central bar (21), that distributes the oil through it, thus falling due to gravity on the primary transmission and control shaft (7), and to the rest of the system through the helical groove, and holes scattered throughout the spider arms (12). The other systems will be oiled by immersion or sprinkling.

Other embodiment are with in the claims modifications of this invention will become apparent to those skilled in the art without departing from the scope or spirit of the invention.

1. A Self Contained Infinitely Variable Transmission with an Integral Mechanical Torque Converter with an Automatic Drive Control, comprising:
a primary traction and control shaft (7);
a cylindrical impeller of increasing diameter (10);
a double coupling shaft (19);
a lock plate (6);
a front epicyclical gear system comprising
a primary gear (1) that receives the motion from the power plant;
an annular gear (2) meshing with said primary gear (1);
a planet gear carrier fixed to said annular gear (2);
a set of two or more planet gears (4) mounted on said planet carrier;
a second annular gear (3) engaging said set of two or more planet gears (4) and coupled to said cylindrical impeller of increasing diameter (10); and,
a sliding sun gear (5) coupled to said primary traction and control shaft (7) and meshing with said set of two or more planet gears (4), wherein the sun gear (5) may slide between two positions, a first position in which the primary traction and control shaft (7) is coupled to said double coupling shaft (19) and a second position in which the sun gear (5) is not coupled to said double coupling shaft (19), but is locked to said lock plate (6);
a control system for controlling the sliding of said sun gear (5) comprising
means (8) for causing said sun gear (5) to slide between said two
positions; and
a friction disk (22);
a torque sensor (9) consisting of
a spring hooking said sun gear (5) through said lock plate (6), when it is at
said second position; and
a mechanism (20) for adjusting the sensitivity of said torque sensor (9);
a rear epicyclical gear system comprising
a system with several rollers (11) moved by said cylindrical impeller of increasing diameter (10);
a set of several rear gears (13) and shafts engaged to said rollers (11);
a set of several pivoting arms (32) that carries said rear gears and shafts;
a second set of several planet gears (14) engaged to said rear gears;
a positioning spider (12) holding said pivoting arms (32) and said second set of planet gears, wherein said positioning spider (12) may be deployed along said primary traction and control shaft (7);
a central gear (15) fitted to said positioning spider, engaged said second set of planet gears (14); and
an outer shaft (16) fixed to said central gear (15);
a central splined bar (21), which jointly with said primary traction and control shaft (7) are able to deploy said positioning spider (12);
a first unidirectional clutch (17) mounted on said cylindrical impeller of increasing diameter (10);
a second unidirectional clutch (18) mounted between said outer shaft (16) and said double coupling shaft (19);
a rear gear train (23, 24, 25, 26, 27, 28, and 29) for multiplying and reverse operation which will be the output of the transmission; and
a transmission housing containing said elements, which receives the reaction force of said central splined bar (21), said friction disk (22), said lock plate (6), said torque sensor (9), and said first unidirectional clutch (17).

2. The Self Contained Infinitely Variable Transmission with an Integral Mechanical Torque Converter with an Automatic Drive Control according to claim 1, wherein:
said primary traction and control shaft (7), primary gear (1), planet gears (4), rollers (11), rear gears and shafts (13), second set of planetary gears (14) and elements (23), (27) and (28) of said rear gear train, have their own axis which is parallel with each other.

3. The Self Contained Infinitely Variable Transmission with an Integral Mechanical Torque Converter with an Automatic Drive Control according to claim 1, wherein:
said sliding sun gear (5), annular gear (2), primary traction and control shaft (7), double coupling shaft (19), friction disk (22), lock plate (6), first unidirectional clutch (17), cylindrical impeller of increasing diameter (10), second annular gear (3), positioning spider (12), central splined bar (21), outer shaft (16) and said second unidirectional clutch (18), and elements (25) and (26) of said rear gear train have a lengthwise axis that is common to all of them.

4. The Self Contained Infinitely Variable Transmission with an Integral Mechanical Torque Converter with an Automatic Drive Control according to claim 1, where said primary gear (1) transmits the motion to said planet carrier, and to said sun gear (5) during the initial acceleration from zero to the optimum speed, by keeping said second annular gear (3) fixed by means of said first unidirectional clutch (17).

5. The Self Contained Infinitely Variable Transmission with an Integral Mechanical Torque Converter with an Automatic Drive Control according to claim 1, where said sun gear (5) has inclined tabs or means that deploy said sun gear (5) backwards when not receiving reaction torque, unlatching it from said lock plate (6), and so transmits the torque to said primary traction and control shaft (7), which engages said double coupling shaft (19) and disengages the pins of said spider (12) from moving.

6. The Self Contained Infinitely Variable Transmission with an Integral Mechanical Torque Converter with an Automatic Drive Control according to claim 1, where said means (8) for causing said sun gear (5) to slide are centrifugal counterweights (8) or means to measure RPM and engage said sun gear (5) to a lock plate (6) and a torque sensor (9) when it reaches a certain speed.

7. The Self Contained Infinitely Variable Transmission with an Integral Mechanical Torque Converter with an Automatic Drive Control according to claim 6, where once the optimum design speed has been achieved, said means (8) or centrifuge counterweights (8), move said sun gear (5) forward, unlatching said primary traction and control shaft (7) from said double coupling shaft (19) and locking it in fixed position to said torque sensor (9).

8. The Self Contained Infinitely Variable Transmission with an Integral Mechanical Torque Converter with an Automatic Drive Control according to claim 7, where once said sun gear (5) is placed in its locked or second position up front, said torque sensor (9) perceives the torque's reaction delivered to said sun gear (5), and will cause said primary traction and control shaft (7) to deploy said spider (12) to a certain longitudinal distance.

9. The Self Contained Infinitely Variable Transmission with an Integral Mechanical Torque Converter with an Automatic Drive Control according to claim 8, where said torque sensor (9) can be a spring which tension can be manually adjusted during the operation of the transmission by said mechanism (20) to surpass the measured force and thus, increase or reduce the operation speed of the power plant engaged to said primary gear (1).

10. The Self Contained Infinitely Variable Transmission with an Integral Mechanical Torque Converter with an Automatic Drive Control according to claim 8, where the primary traction and control shaft (7) is engaged to said spider (12) by any means that can be pins running through a helical groove and a slotted central bar, and depending on the torque that surpasses said sensing system, will deploy said positioning spider (12) lengthwise.

11. The Self Contained Infinitely Variable Transmission with an Integral Mechanical Torque Converter with an Automatic Drive Control according to claim 1, where said impeller of growing diameter (10) may be conic or parabolic shaped, and may have lengthwise grooves along its inner surface.

12. The Self Contained Infinitely Variable Transmission with an Integral Mechanical Torque Converter with an Automatic Drive Control according to claim 1, where once said sun gear (5) is fixed to said torque sensor (9), said cylindrical impeller (10) is released from said unidirectional clutch, transmitting the traction to said rollers system (11).

13. The Self Contained Infinitely Variable Transmission with an Integral Mechanical Torque Converter with an Automatic Drive Control according to claim 1, where said system with several rollers (11) may be a pitching roller system comprising:
two or more parabolic shaped rollers (11A),
two or more inclined gears (11C) fixed concentrically to said parabolic shaped rollers (11A)
two or more guide gears (11B) engaged to said inclined gears (11C) and with a shaft coupled to said rear gears.

14. The pitching roller system according to claim 13, where the parabolic shaped rollers (11A) have an axle not parallel to the axle of said guide gears (11B),

15. The pitching roller system according to claim 13, where the axle of said parabolic shaped rollers (11A) that incorporates said inclined gear (11C) which rotates and positions radially in a 180° range around said guide gear linked to said shaft and rear gear (11B) as said spider moves axially.

16. The pitching roller system according to claim 13, where said parabolic shaped rollers (11A) have helical grooves corresponding to the contact angle with which they match with said impellers grooves.

17. The Self Contained Infinitely Variable Transmission with an Integral Mechanical Torque Converter with an Automatic Drive Control according to claim 1, where said roller system (11) is engaged by its said rear gear to said second set of planet gears to said central gear that is joined to said outer shaft (16) and to said double coupling shaft (19) by said second unidirectional clutch (18).

18. The Self Contained Infinitely Variable Transmission with an Integral Mechanical Torque Converter with an Automatic Drive Control according to claim 1, where said second unidirectional clutch (18), restricts said outer shaft (16) from spinning during the initial transmission operation, in order to allow the free rotation of said double coupling shaft (19), but once said outer shaft (16) reaches the same speed as said double coupling shaft (19), said second unidirectional clutch (18) will then match speeds of both shafts so that said outer shaft (16) will now transmit the traction, and the sequence change is synchronized.

19. The Self Contained Infinitely Variable Transmission with an Integral Mechanical Torque Converter with an Automatic Drive Control according to claim 1, where said rear gear train can have several rates including reverse and neutral.

20. The Self Contained Infinitely Variable Transmission with an Integral Mechanical Torque Converter with an Automatic Drive Control according to claim 19, where said outer shaft (19) engages with said rear gear train and can sequentially shift upwards or downwards by means of the connecting link (29) every time said outer shaft (16) reaches certain longitudinal deployment.
